(19) United States
(12) Patent Application Publication
(10) Pub. No.: US 2012/0148021 A1
(43) Pub. Date: Jun. 14, 2012

(54) RADIATION IMAGING SYSTEM AND RADIOGRAPHIC IMAGE PROCESSING METHOD

(75) Inventor: Hiroyasu ISHII, Kanagawa (JP)

(73) Assignee: FUJIFILM CORPORATION, Tokyo (JP)

(21) Appl. No.: 13/307,861

(22) Filed: Nov. 30, 2011

(30) Foreign Application Priority Data
Dec. 14, 2010 (JP) 2010-278163

(51) Int. Cl. G01N 23/04

(52) U.S. Cl. 378/62

(57) ABSTRACT

An image processor includes a positional deviation amount calculating section, a positional deviation amount correcting section, a differential phase image generator, and a subtraction processing section. The positional deviation amount calculating section calculates a positional deviation amount in each scan position between preliminary radiography and actual radiography by detecting the difference between an intensity modulation signal produced from image data obtained in the preliminary radiography and that produced from image data obtained in the actual radiography. The positional deviation amount correcting section corrects scan position data, which is used by the differential phase image generator in producing a first differential phase image in the actual radiography, using the calculated positional deviation amount. The subtraction processing section subtracts a second differential phase image produced in the preliminary radiography from the first differential phase image produced in the actual radiography.

### BACKGROUND OF THE INVENTION

1. Field of the Invention

The present invention relates to a radiation imaging system using a fringe scanning method, and a radiographic image processing method thereof.

2. Description Related to the Prior Art

X-rays are used as a probe for imaging inside of an object without incision, due to the characteristic that attenuation of the X-rays depends on the atomic number of an element constituting the object and the density and thickness of the object. Radiography using the X-rays becomes widespread in fields of medical diagnosis, nondestructive inspection, and the like.

In a conventional X-ray imaging system for capturing a radiographic image of the object, the object to be examined is disposed between an X-ray source for emitting the X-rays and an X-ray image detector for detecting the X-rays. In this situation, the X-rays emitted from the X-ray source to the X-ray image detector are attenuated (absorbed) in accordance with the characteristics (atomic number, density, and thickness) of material existing in an X-ray path leading to the X-ray image detector. After that, the X-rays are incident upon pixels of the X-ray image detector, so the X-ray image detector detects an X-ray absorption contrast image of the object. As the X-ray image detector, a flat panel detector (FPD) composed of semiconductor circuitry is widely used, in addition to a combination of an X-ray intensifying screen and a film, and photostimulable phosphor.

The smaller the atomic number of the element constituting the material, the lower X-ray absorptivity the material has. Thus, there is a problem that the X-ray absorption contrast image of in vivo soft tissue, soft materials, or the like cannot have sufficient image contrast because of the low X-ray absorptivity. Taking a case of an arthrosis of a human body as an example, both of articular cartilage and its surrounding synovial fluid have water as a predominant ingredient, and there is little difference in the X-ray absorptivity therebetween. Thus, the X-ray absorption contrast image of the arthrosis cannot have sufficient contrast.

With this problem as a backdrop, X-ray phase imaging is actively researched in recent years. In the X-ray phase imaging, an image (hereinafter called phase contrast image) is obtained based on phase change (angular change) of the X-rays, which is caused by difference in refractivity of the object, instead of intensity change of the X-rays by the object. When the X-rays are incident upon the object, the phase change of the X-rays is larger than the intensity change. Accordingly, the X-ray phase imaging using the phase change allows obtainment of an image with high contrast, even if the object is constituted of materials with low X-ray absorptivity.

Adopting the X-ray phase imaging, there is proposed a radiation imaging system that captures the phase contrast image using the Talbot effect (refer to U.S. Pat. No. 7,180,979 corresponding to Japanese Patent No. 4445397 and Applied Physics Letters Vol. 81, No. 17, page 3287 written by C. David et al. on October 2002, for example). In this system, first and second grids are disposed in parallel with a predetermined distance therebetween. By the Talbot effect, a self image of the first grid is formed in the position of the second grid. The second grid applies intensity modulation to the self image, and produces a fringe image. The phase information of the object is reflected in the fringe image, which is obtained by the intensity modulation of the self image.

There are various methods for obtaining the phase information of the object from the fringe image, such as a fringe scanning method, a moiré interferometric method, and a Fourier transform method. The U.S. Pat. No. 7,180,979 uses the fringe scanning method. In the fringe scanning method, an image is captured whenever the second grid is translationally moved (scanned) relative to the first grid in a direction approximately orthogonal to a grid direction by a predetermined amount smaller than a grid pitch, so a plurality of fringe images are obtained. From the plural fringe images, a differential phase value corresponding to an amount of the phase change of the X-rays is obtained based on the intensity change of each individual pixel value. Based on a two-dimensional image (differential phase image) of the differential phase values, the phase contrast image is produced. The fringe scanning method is available in an imaging system using laser light, instead of the X-rays (refer to Applied Optics Vol. 37, No. 26, page 6227 written by Hector Canabal et al. on September 1998, for example).

In the fringe scanning method, however, if manufacturing error, distortion, misalignment or the like occurs in the first and second grids, a value irrelevant to the object is added to the differential phase value of each pixel. To solve this problem, the U.S. Pat. No. 7,180,979 discloses that the differential phase image is captured in each of actual radiography performed in the presence of the object and preliminary radiography performed in the absence of the object. By subtracting a second differential phase image obtained in the preliminary radiography from a first differential phase image obtained in the actual radiography, the differential phase image ascribable to the object itself is obtained.

This correction method is effective at correcting a factor common between the preliminary radiography and the actual radiography such as the manufacturing error and distortion of the first and second grids. However, this correction method is ineffective at correcting a deviation in the scan position between the preliminary radiography and the actual radiography. The U.S. Pat. No. 7,180,979 describes that the first differential phase image and the second differential phase image are calculated by the same expression. For this reason, it is obvious that the U.S. Pat. No. 7,180,979 does not consider the deviation in the scan position.

### SUMMARY OF THE INVENTION

An object of the present invention is to provide a radiation imaging system and a radiographic image processing method that can correct an artifact caused by deviation in a scan position between preliminary radiography and actual radiography.

To achieve the above and other objects, a radiation imaging system according to the present invention includes first and second gratings, a scan mechanism, a radiographic image detector, a differential phase image generator, a positional deviation amount calculating section, a positional deviation amount correcting section, and a subtraction processing section. The first and second gratings are oppositely disposed with coincidence of a grating direction. The scan mechanism changes a relative position between the first and second gratings to a direction orthogonal to the grating direction, so as to sequentially set the relative position at plural scan positions. The radiographic image detector captures an image of radiation applied from a radiation source through the first and second gratings and produces image data, whenever the relative position is set at each of the scan positions. The differential phase image generator produces a differential phase image by obtaining a phase shift amount of an intensity modulation signal. The intensity modulation signal represents a change of each pixel value contained in the image data relative to the scan positions. The differential phase image generator produces a first differential phase image from the image data obtained in actual radiography performed in the presence of a sample, and produces a second differential phase image from the image data obtained in preliminary radiography performed in the absence of the sample. The positional deviation amount calculating section calculates a positional deviation amount in each of the scan positions between the preliminary radiography and the actual radiography by detection of the difference between the intensity modulation signal obtained in the preliminary radiography and the intensity modulation signal obtained in the actual radiography. The positional deviation amount correcting section corrects scan position data used by the differential phase image generator in producing one of the first and second differential phase images, based on the positional deviation amount. The subtraction processing section subtracts the second differential phase image from the first differential phase image.

It is preferable that the radiographic image detector has plural pixels, and the positional deviation amount calculating section statistically calculates the positional deviation amount in each of the scan positions with use of the intensity modulation signal of each of the pixels. It is also preferable that the radiographic image detector has a sample non-detection area upon which the radiation emitted from the radiation source is incident without passing through the sample, and the plural pixels used in calculation of the positional deviation amount belong to the sample non-detection area. It is preferable that the positional deviation amount calculating section calculates the positional deviation amount of each of the scan positions on a pixel-by-pixel basis, and determines the positional deviation amount of each of the scan positions by detecting a peak value, an average value, or a median of frequency distribution of a pixel number relative to the positional deviation amount.

The positional deviation amount calculating section preferably interpolates the pixel value between the scan positions next to each other in the intensity modulation signal obtained from one of the pixels in one of the actual radiography and the preliminary radiography, and calculates with reference to the interpolated intensity modulation signal the positional deviation amount at each of the scan positions of the intensity modulation signal obtained from the same pixel in the other one of the actual radiography and the preliminary radiography. The positional deviation amount calculating section may perform linear interpolation of the pixel value between the scan positions next to each other, or may perform extrapolation of the pixel value in the intensity modulation signal obtained in the actual radiography or the preliminary radiography, to make the intensity modulation signal into a periodic wave of more than one period.

The differential phase image generator preferably calculates the phase shift amount of the intensity modulation signal by using a computation expression based on least square.

The radiation imaging system may further include a phase contrast image generator for integrating the differential phase image produced by the differential phase image generator in a direction of changing the relative position, to produce a phase contrast image.

The first grating may be an absorption grating, and may project the radiation incident from the radiation source onto the second grating in a geometrical-optics manner. In another case, the first grating may be a phase grating, and may induce a Talbot effect in the radiation incident from the radiation source to form a self image in a position of the second grating.

A radiographic image processing method includes the steps of calculating a positional deviation amount in each of the scan positions between preliminary radiography and actual radiography by detecting the difference between the intensity modulation signal obtained in the preliminary radiography performed in the absence of the sample and the intensity modulation signal obtained in the actual radiography performed in the presence of the sample; with use of the positional deviation amount, correcting scan position data used in producing one of first and second differential phase images by the differential phase image generator; with use of the corrected scan position data, producing by the differential phase image generator the first differential phase image from the image data obtained in the actual radiography and the second differential phase image from the image data obtained in the preliminary radiography; and subtracting the second differential phase image from the first differential phase image.

According to the present invention, the positional deviation amount in each scan position between the preliminary radiography and the actual radiography is calculated by the detection of the difference between the intensity modulation signal obtained in the preliminary radiography and that obtained in the actual radiography. Then, the scan position data, which is used in producing the differential phase image, is corrected using the calculated positional deviation amount, such that the scan positions coincide in the actual and preliminary radiography. After that, the second differential phase image produced in the preliminary radiography is subtracted from the first differential phase image produced in the actual radiography. Therefore, it is possible to correct an artifact that is ascribable to the deviation of each scan position between the preliminary radiography and the actual radiography.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view of an X-ray imaging system;

FIG. 2 is a schematic perspective view of a case of an imaging unit;

FIG. 3 is a schematic view of an X-ray image detector;

FIG. 4 is an explanatory view for explaining an angle of refraction and a shift amount of an X-ray transmitted through an object;

FIG. 5 is an explanatory view of a fringe scanning method;

FIG. 6 is a block diagram of an image processor;

FIG. 7 is a graph showing examples of intensity modulation signals outputted from a pixel in a sample non-detection area during actual radiography and preliminary radiography;

FIG. 8 is a graph that explains a method for calculating a positional deviation amount from a scan position;

FIG. 9 is a graph showing examples of the positional deviation amounts calculated by a positional deviation amount calculating section; and

FIG. 10 is a graph showing an example of the frequency distribution of a pixel number with respect to the positional deviation amount.

### DESCRIPTION OF THE PREFERRED EMBODIMENTS

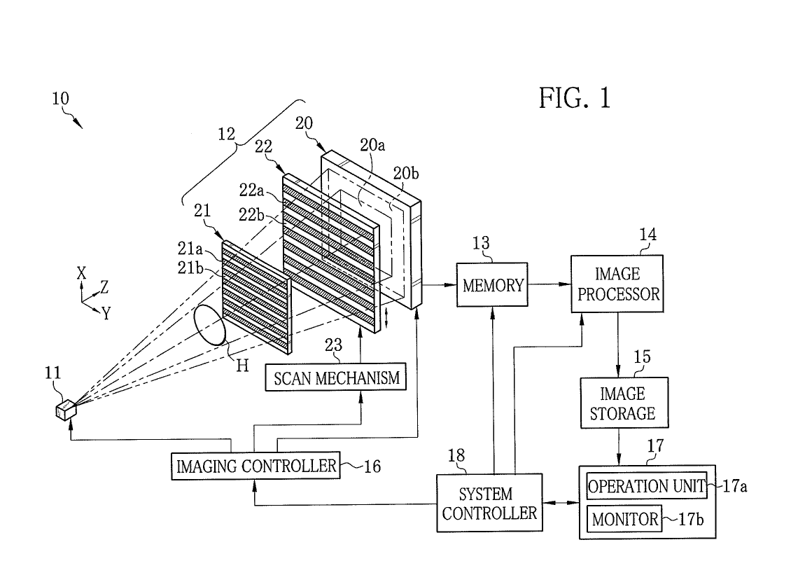

As shown in FIG. 1, an X-ray imaging system 10 is constituted of an X-ray source 11, an imaging unit 12, a memory 13, an image processor 14, image storage 15, an imaging controller 16, a console 17, and a system controller 18. The X-ray source 11 has a rotating anode type of X-ray tube and a collimater for limiting an irradiation field of X-rays, for example, and emits the X-rays to a sample H.

The imaging unit 12 is constituted of an X-ray image detector 20, a first grating 21, and a second grating 22. The first and second gratings 21 and 22 being absorption gratings are opposed to the X-ray source 11 with respect to a Z direction being an X-ray propagation direction. There is provided a space between the X-ray source 11 and the first grid 21 to dispose the sample H therein. The X-ray image detector 20 is, for example, a flat panel detector (FPD) using semiconductor circuitry. The X-ray image detector 20 is disposed behind the second grating 22 such that its detection surface is orthogonal to the Z direction.

The detection surface of the X-ray image detector 20 is divided into a sample detection area 20a and a sample non-detection area 20b. On the sample detection area 20a, the X-rays that have passed through the sample H are mainly incident through the first and second gratings 21 and 22. On the other hand, the X-rays that have propagated through space around the sample H without passing through the sample H itself are incident on the sample non-detection area 20b through the first and second gratings 21 and 22.

The first grating 21 is provided with a plurality of X-ray absorbing sections 21a and X-ray transparent sections 21b that extend in a Y direction being one direction in a plane orthogonal to the Z direction. The X-ray absorbing sections 21a and the X-ray transparent sections 21b are alternately arranged in an X direction orthogonal to both the Z and Y directions, so as to form a stripe pattern. Likewise, the second grating 22 is provided with a plurality of X-ray absorbing sections 22a and X-ray transparent sections 22b that extend in the Y direction and are alternately arranged in the X direction. The X-ray absorbing sections 21a and 22a are made of metal having X-ray absorptivity, such as gold (Au) or platinum (Pt). The X-ray transparent sections 21b and 22b are made of material having X-ray transparency, such as silicon (Si) or resin.

The memory 13 temporarily stores image data read out of the imaging unit 12. The image processor 14 produces a phase contrast image based on the image data of plural frames stored in the memory 13. The image storage 15 records the phase contrast image produced by the image processor 14. The imaging controller 16 controls the X-ray source 11 and the imaging unit 12.

The console 17 includes an operation unit 17a for inputting imaging conditions and execution commands of preliminary radiography and actual radiography, as described later, and a monitor 17b for displaying radiography information and a captured image. The system controller 18 performs centralized control of every part in accordance with a signal inputted from the operation unit 17a.

The imaging unit 12 includes a scan mechanism 23, which translationally moves the second grating 22 in the X direction to change the position of the second grating 22 relative to the first grating 21. The scan mechanism 23 is composed of, for example, an actuator such as a piezoelectric element. The scan mechanism 23 is driven by the imaging controller 16 during the performance of fringe scanning. Although details will be described later on, the image data that is captured by the X-ray image detector 20 in each scan position during performance of the fringe scanning is written to the memory 13.

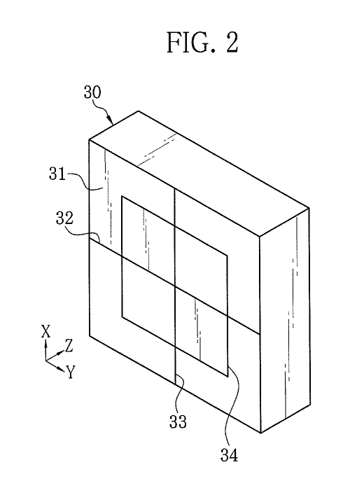

The imaging unit 12 having the above structure is contained in a rectangular case 30, as shown in FIG. 2. In an X-ray incident surface 31 of the case 30, center lines 32 and 33 and a rectangular frame line 34 are printed. The center lines 32 and 33 indicate centers with respect to the X and Y directions, respectively. The frame line 34 indicates a border between the sample detection area 20a and the sample non-detection area 20b of the X-ray image detector 20. The outside of the frame line 34 corresponds to the sample non-detection area 20b.

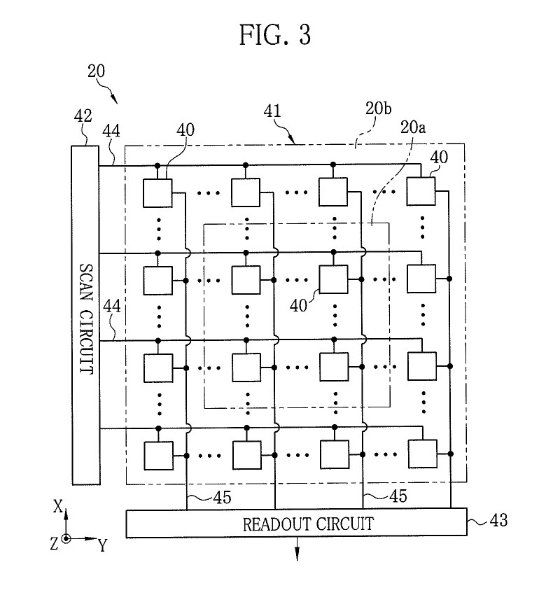

As shown in FIG. 3, the X-ray image detector 20 is constituted of an imaging section 41, a scan circuit 42, and a readout circuit 43. The imaging section 41 has a plurality of pixels 40 arranged in two dimensions along the X and Y directions on an active matrix substrate. Each of the pixels 40 converts the X-rays into electric charge and accumulates the electric charge. The scan circuit 42 controls readout timing of the electric charge from the pixels 40. The readout circuit 43 reads out the electric charge from the pixels 40, and converts the electric charge into the image data, and outputs the image data. The scan circuit 42 is connected to every pixel 40 by scan lines 44 on a row-by-row basis. The readout circuit 43 is connected to every pixel 40 by signal lines 45 on a column-by-column basis. The arrangement pitch of the pixels 40 is in the order of 100 μm in each of the X and Y directions.

The pixel 40 is a direct conversion type X-ray detecting element, in which a conversion layer (not shown) made of amorphous selenium or the like directly converts the X-rays into the electric charge, and the converted electric charge is accumulated in a capacitor (not shown) that is connected to an electrode below the conversion layer. Each pixel 40 is provided with a TFT switch (not shown). A gate electrode of the TFT switch is connected to the scan line 44, and a source electrode thereof is connected to the capacitor, and a drain electrode thereof is connected to the signal line 45. Upon turning on the TFT switch by a drive pulse from the scan circuit 42, the electric charge accumulated in the capacitor is read out to the signal line 45.

Each pixel 40 may be an indirect conversion type of X-ray detecting element, in which a scintillator (not shown) made of gadolinium oxide (Gd₂O₃), cesium iodide (CsI), or the like converts the X-rays into visible light, and a photodiode (not shown) converts the visible light into the electric charge. The X-ray image detector 20 is not limited to the TFT panel-based FPD, but another type of radiographic image detector based on a solid-state image sensor such as a CCD or CMOS image sensor may be used instead.

The readout circuit 43 includes an integration amplifier, an A/D converter, a correction section, and the like (none of them is shown). The integration amplifier converts by integration the electric charge outputted from the pixels 40 through the signal lines 45 into an image signal being a voltage signal. The A/D converter converts the image signal produced by the integration amplifier into digital image data. The correction section applies dark current correction, gain correction, linearity correction, and the like to each pixel value composing the image data, and inputs the corrected image data to the memory 13.

The scan circuit 42 and the readout circuit 43 are controlled by the system controller 18 via the imaging controller 16. The imaging section 41 is divided into the sample detection area 20a and the sample non-detection area 20b, as described above. The sample detection area 20a and the sample non-detection area 20b have the pixels 40 of the same structure. The system controller 18 distinguishes the pixels 40 laid out in the sample detection area 20a from the pixels 40 laid out in the sample non-detection area 20b, in accordance with an address indicating each scan line 44 and each signal line 45.

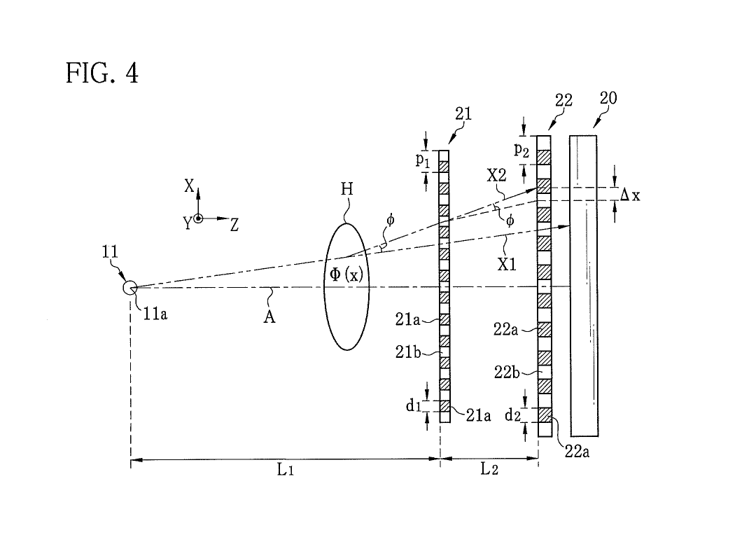

In FIG. 4, the X-rays emitted from the X-ray source 11 are a cone beam divergent from the X-ray focus 11a. Thus, a first periodic pattern image (hereinafter called G1 image) produced by the X-rays passed through the first grating 21 is magnified in proportion to a distance from the X-ray focus 11a. The arrangement pitch p₂ and width d₂ of the X-ray absorbing sections 22a of the second grating 22 in the X direction are determined by the following expressions (1) and (2), with use of the length L₁ between the X-ray focus 11a and the first grating 21, the length L₂ between the first and second gratings 21 and 22, and the arrangement pitch p₁ and width d₁ of the X-ray absorbing sections 21a of the first grating 21.

$$\begin{matrix}{p}_{2} = \frac{{L}_{1} + {L}_{2}}{{L}_{1}} {p}_{1} & ( 1 ) \\ {d}_{2} = \frac{{L}_{1} + {L}_{2}}{{L}_{1}} {d}_{1} & ( 2 )\end{matrix}$$

For example, the arrangement pitch p₂ is 5 μm, and the width d₂ is half of the arrangement pitch p₂, namely 2.5 μm. The thickness of the X-ray absorbing sections 21a in the Z direction is in the order of 100 μm, for example, in consideration of vignetting of the cone beam of X-rays emitted from the X-ray source 11.

The first and second gratings 21 and 22 project the X-rays passed through the X-ray transparent sections 21a and 22a in a geometrical-optics manner. To be more specific, since the widths of the X-ray transparent sections 21b and 22b in the X direction (equal to the widths d₁ and d₂) are set enough larger than the peak wavelength of the X-rays emitted from the X-ray source 11, the first and second gratings 21 and 22 straight pass almost all X-rays without diffraction. When tungsten is used as the rotating anode of the X-ray tube in the X-ray source 11 and tube voltage is 50 kV, for example, the peak wavelength of the X-rays is approximately 0.4 Å. In this case, the allowable widths of the X-ray transparent sections 21b and 22b are in the order of 1 to 10 μm.

The length L₂ is limited to the Talbot distance in the case of a Talbot interferometer. In this embodiment, however, the length L₂ can be established irrespective of the Talbot distance, because the first and second gratings 21 and 22 project the X-rays in a geometrical-optics manner.

The imaging unit 12 according to this embodiment does not compose the Talbot interferometer, as described above. However; with the assumption that the first grating 21 diffracts the X-rays and brings about the Talbot inference, the Talbot distance Zₘ is represented by the following expression (3), using the arrangement pitches p₁ and p₂, the wavelength λ of the X-rays, and a positive integer m:

$${Z}_{m} = m \frac{{p}_{1} {p}_{2}}{λ} \qquad ( 3 )$$

The expression (3) represents the Talbot distance in a case where the X-ray source 11 emits the cone beam of X-rays, and is known by Japanese Journal of Applied Physics Vol. 47, No. 10, page 8077, written on October 2008 by Atsushi Momose et al.

In this embodiment, the length L₂ can be set irrespective of the Talbot distance Zₘ. Therefore, the length L₂ is set shorter than the minimum Talbot distance Z₁ defined at m=1, for the purpose of slimming the imaging unit 12. In other words, the length L₂ satisfies the following expression (4):

$${L}_{2} < \frac{{p}_{1} {p}_{2}}{λ} \qquad ( 4 )$$

In the imaging unit 12 having the above structure, the first grating 21 produces the G1 image. Then, the second grating 22 applies the intensity modulation to the G1 image by superimposition, and produces a second periodic pattern image (hereinafter called G2 image). The X-ray image detector 20 captures the G2 image. If a slight difference occurs between a pattern period of the G1 image formed in the position of the second grating 22 and a grating period (arrangement pitch p₂) of the second grating 22 due to a positioning error or the like, a moiré fringe emerges in the G2 image. Even when the moiré fringe emerges, no problem occurs in obtaining an intensity modulation signal, as described later, if a period of the moiré fringe differs from the size of an X-ray receiving area of the pixel 40.

When the sample H is disposed between the X-ray source 11 and the first grating 21, the G2 image is modulated by the sample H. This modulation amount depends on angles of the deflected X-rays due to the refraction.

Next, a fringe scanning method will be described. FIG. 4 shows an example of a route of the X-ray that is refracted according to phase shift amount distribution Φ(x) of the sample H with respect to the X direction. A reference numeral X1 indicates a route of the X-ray that travels in a straight line in the absence of the sample H. The X-ray traveling in this route X1 passes through the first and second gratings 21 and 22, and is incident upon the X-ray image detector 20. A reference numeral X2, on the other hand, indicates a route of the X-ray that is refracted by the sample H in the presence of the sample H. The X-ray traveling in this route X2 passes through the first grating 21, and then is absorbed by the X-ray absorbing section 22a of the second grating 22.

The phase shift amount distribution Φ(x) of the sample H is represented by the following expression (5):

$$Φ ( x ) = \frac{2 π}{λ} \int [ 1 - n ( x , z ) ] d z \qquad ( 5 )$$

Wherein, n(x, z) represents refractive index distribution of the sample H. For the sake of simplicity, a Y coordinate is omitted in the expression (5).

The G1 image formed by the first grating 21 in the position of the second grating 22 is displaced in the X direction by an amount corresponding to a refraction angle φ due to the refraction of the X-ray in passing through the sample H. This displacement Δx by the refraction is approximately represented by the following expression (6), on condition that the refraction angle φ is sufficiently small:

Δx≈L₂φ (6)

The refraction angle φ is represented by the following expression (7), using the wavelength λ of the X-ray and the phase shift amount distribution Φ(x):

$$φ = \frac{λ}{2 π} \frac{\partial Φ ( x )}{\partial x} \qquad ( 7 )$$

As is obvious from the above expressions, the displacement Δx is related to the phase shift amount distribution Φ(x) of the sample H. Furthermore, the displacement Δx and the refraction angle φ are related to a phase shift amount ψ of the intensity modulation signal of each pixel 40 by the sample H, as is represented by the following expression (8). The intensity modulation signal is a waveform signal that represents change of a pixel value with respect to the scan position of the second grating 22 relative to the first grating 21, though detail will be described later.

$$ψ = \frac{2 π}{{p}_{2}} Δ x = \frac{2 π}{{p}_{2}} {L}_{2} φ \qquad ( 8 )$$

Thus, determination of the phase shift amount ψ of the intensity modulation signal of each pixel 40 leads to obtainment of the refraction angle φ using the expression (8), and furthermore leads to obtainment of the phase shift amount distribution Φ(x) using the expression (7).

In the fringe scanning method, one of the first and second gratings 21 and 22 is translationally moved (scanned) relative to the other in the X direction. The G2 image is captured, whenever the first and second gratings 21 and 22 are set at each individual predetermined scan position. In this embodiment, the first grating 21 is fixed, while the second grating 22 is moved in the X direction by the scan mechanism 23. With the movement of the second grating 22, the moiré fringes emerging in the G2 image vary. When the movement distance reaches the grating period (arrangement pitch p₂) of the second grating 22, the moiré fringes return to the original positions.

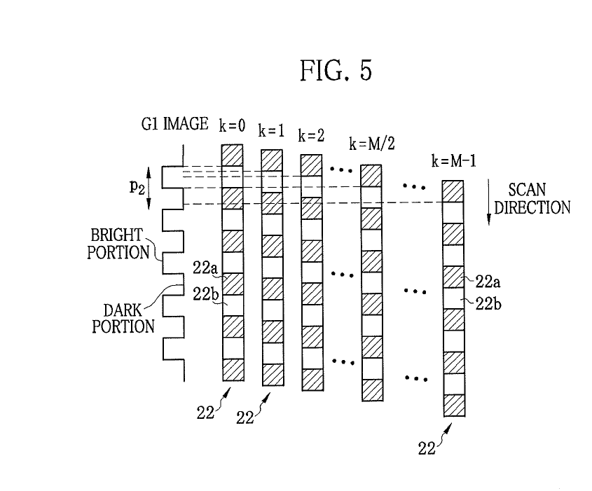

FIG. 5 schematically shows a state of moving the second grating 22 by a scan pitch of p₂/M, in which the arrangement pitch p₂ is divided by M (integer of 2 or more). The scan mechanism 23 stepwise moves the second grating 22 to each of an M number of scan positions represented by k=0, 1, 2, . . . , M-1.

In the position of k=0, the X-rays that have not been refracted by the sample H mainly pass through the second grating 22. While the second grating 22 is successively moved to k=1, 2, . . . , a non-refracted X-ray component being the X-rays having not been refracted by the sample H is decreased, and a refracted X-ray component being the X-rays having been refracted by the sample H is increased in the X-rays detected through the second grating 22. Especially, in the position of k=M/2, substantially only the refracted X-ray component is detected through the second absorption grating 22. After the position of M/2, on the contrary, the refracted X-ray component is decreased and the non-refracted X-ray component is increased in the X-rays detected through the second absorption grating 22.

Since the X-ray image detector 20 captures the G2 image in each of the scan positions of k=0, 1, 2, . . . , M-1, an M number of image data is recorded to the memory 13. An M number of pixel values obtained on a pixel-by-pixel basis compose the intensity modulation signal. The obtainment of the M number of image data by the fringe scanning is carried out in each of actual radiography performed in the presence of the sample H and preliminary radiography performed in the absence of the sample H, and the obtained image data is recorded to the memory 13.

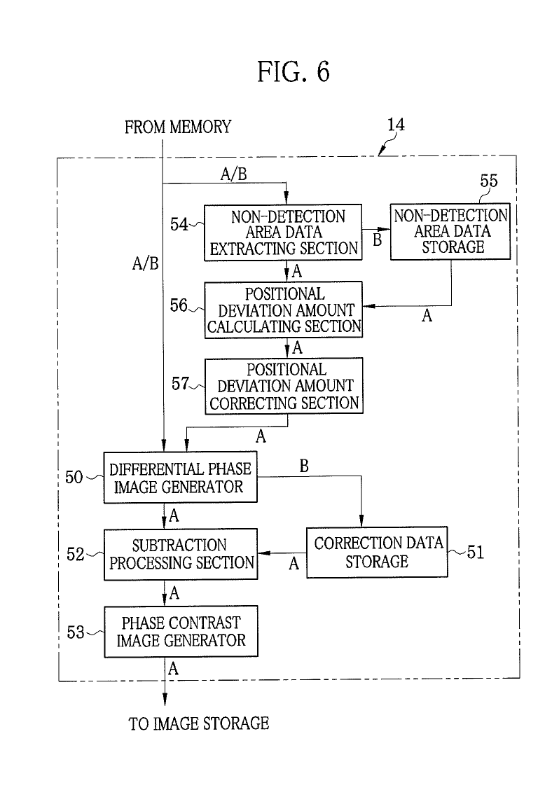

Next, the configuration of the image processor 14 will be described. As shown in FIG. 6, the image processor 14 is constituted of a differential phase image generator 50, correction data storage 51, a subtraction processing section 52, a phase contrast image generator 53, a non-detection area data extracting section 54, non-detection area data storage 55, a positional deviation amount calculating section 56, and a positional deviation amount correcting section 57. In FIG. 6, “A” attached to an arrow indicates a route of various types of data flowing in components that operate during the actual radiography. “B” indicates a route of various types of data flowing in components that operate during the preliminary radiography. “A/B” indicates a route of various types of data flowing in components operate during both the actual radiography and the preliminary radiography.

To the differential phase image generator 50, the M number of image data, which is obtained by the fringe scanning and recorded to the memory 13 during the actual and preliminary radiography, is read out. The differential phase image generator 50 produces the differential phase image from the M number of image data. A first differential phase image produced during the actual radiography is inputted to the subtraction processing section 52. A second differential phase image produced during the preliminary radiography is inputted to the correction data storage 51 as correction data. The correction data storage 51 stores the inputted second differential phase image, and inputs the second differential phase image to the subtraction processing section 52 in the actual radiography.

The subtraction processing section 52 carries out a correction process by which the second differential phase image is subtracted from the first differential phase image, and inputs a corrected differential phase image to the phase contrast image generator 53. The phase contrast image generator 53 integrates the corrected differential phase image in the X direction to produce the phase contrast image. The generated phase contrast image is inputted to the image storage 15.

The non-detection area data extracting section 54 extracts data (hereinafter called non-detection area data) corresponding to the sample non-detection area 20b from each of the M number of image data recorded to the memory 13. First non-detection area data extracted during the actual radiography is inputted to the positional deviation amount calculating section 56. On the other hand, second non-detection area data extracted during the preliminary radiography is inputted to the non-detection area data storage 55. The non-detection area data storage 55 records the inputted second non-detection area data, and inputs the second non-detection area data to the positional deviation amount calculating section 56 in the actual radiography.

Although details will be described later, the positional deviation amount calculating section 56 statistically calculates a positional deviation amount αₖ of the scan position k in the actual radiography from that in the preliminary radiography based on the inputted first and second non-detection area data, and inputs the calculated positional deviation amount αₖ to the positional deviation amount correcting section 57. The positional deviation amount correcting section 57 makes a correction by adding the deviation amount αₖ to the scan position data k in the actual radiography, and supplies the corrected scan position data k+αₖ to the differential phase image generator 50.

During the preliminary radiography, the differential phase image generator 50 calculates the phase shift amount ψ of the intensity modulation signal based on the scan position data k having regular intervals in which the arrangement pitch p₂ is divided by M, to produce the second differential phase image. During the actual radiography, on the other hand, the differential phase image generator 50 calculates the phase shift amount ψ of the intensity modulation signal based on the corrected scan position data k+αₖ having irregular intervals, to produce the first differential phase image.

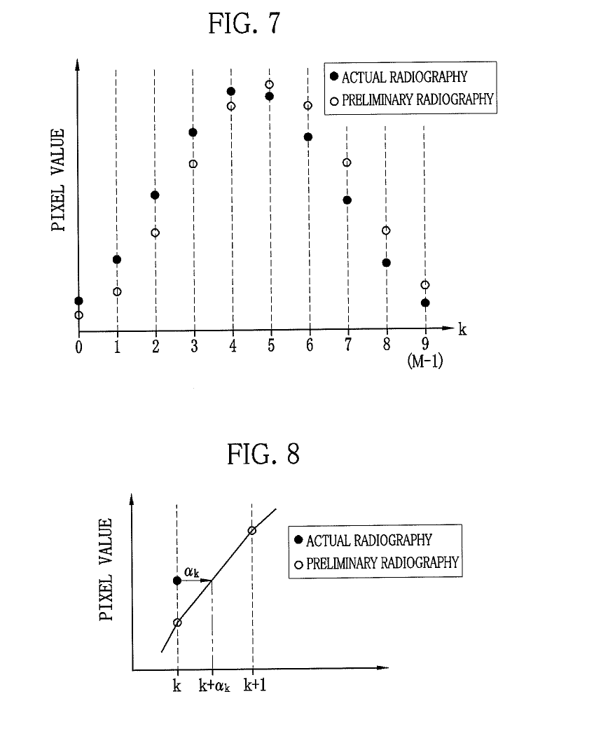

A method for calculating the positional deviation amount αₖ by the positional deviation amount calculating section 56 will be described. FIG. 7 shows examples of the intensity modulation signals of the single pixel 40 based on the first and second non-detection area data obtained in the actual and preliminary radiography. FIG. 4 shows the case of M=10, and the pixel values of the intensity modulation signals are plotted on the graph on the assumption that the scan positions k are situated at the regular intervals. In FIG. 4, deviation of the intensity modulation signal between the actual radiography and the preliminary radiography is mainly caused by the deviation of the scan position k between the actual radiography and the preliminary radiography.

The positional deviation amount calculating section 56 determines the deviation amount αₖ of the scan position k by calculating a deviation of each pixel value during the actual radiography relative to the intensity modulation signal of the preliminary radiography. To be more specific, as shown in FIG. 8, a pixel value is linearly interpolated between the adjoining scan positions based on the M number of pixel values of each pixel 40 contained in the second non-detection area data obtained in the preliminary radiography, to generate the continuous intensity modulation signal. After that, as to the M number of pixel values of each pixel 40 contained in the first non-detection area data obtained in the actual radiography, the deviation amount αₖ from the linearly interpolated intensity modulation signal is determined in each scan position k. Note that, curvilinear interpolation may be used instead of the linear interpolation.

The positional deviation amount αₖ is preferably in the range of −1 to 1. However, since the intensity modulation signal in the preliminary radiography does not exist out of the range of 0≦k≦M-1, the positional deviation amount α₀ at the scan position k=0 or the positional deviation amount α_{M-1} at the scan position k=M-1 is out of the range of −1 to 1. In FIG. 7, the positional deviation amount α₉ is out of the range of −1 to 1, and hence the positional deviation amount α₉ cannot be precisely determined only by the interpolation shown in FIG. 7. For this reason, the positional deviation amount calculating section 56 extrapolates the intensity modulation signal in the preliminary radiography out of the range of 0≦k≦M-1 using straight or curved lines to make the intensity modulation signal into a periodic wave of more than one period. After that, the positional deviation amounts αₖ are determined.

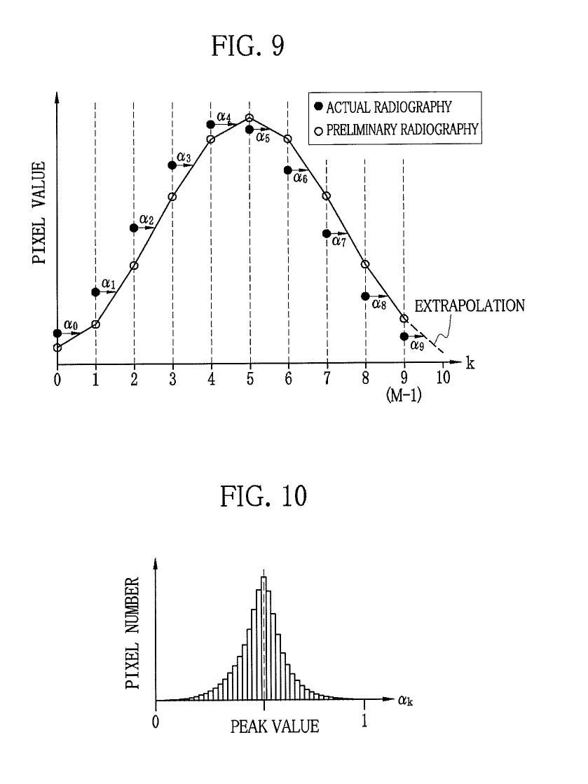

In FIG. 9, arrows represent the positional deviation amounts αₖ determined by the positional deviation amount calculating section 56 using the intensity modulation signal shown in FIG. 7. In this example, the intensity modulation signal in the preliminary radiography is shifted to a positive direction of k relative to the intensity modulation signal in the actual radiography. Thus, with the extrapolation of the intensity modulation signal in the preliminary radiography out of the range of k≧M-1, the positional deviation amount α₉ is calculated at a value in the range of 0 to 1. Note that, instead of the extrapolation, scan operation may be carried out for more than one period, and the intensity modulation signal outside the range of 0≦k≦M-1 may be experimentally obtained.

Furthermore, the positional deviation amount calculating section 56 calculates the positional deviation amount αₖ of every pixel 40 in the sample non-detection area 20b, and statistically determines a set of positional deviation amounts αₖ. This is because the same positional deviation amount αₖ is not always calculated for every pixel 40 in the sample non-detection area 20b. To be more specific, as shown in FIG. 10, the frequency distribution of pixel number relative to the positional deviation amount αₖ is created to detect a peak value (mode). This peak value is set at the positional deviation amount αₖ. This operation is carried out in each scan position k. Note that, instead of the peak value, an average value or a median value of the frequency distribution may be detected.

Next, a method for calculating the phase shift amount ψ(x) of the intensity modulation signal using the corrected scan position data k+αₖ will be described. First, a pixel value Iₖ(x) at the scan position k+αₖ is represented by the following expression (9):

$${I}_{k} ( x ) = {A}_{0} + {\sum }_{n > 0} {A}_{n} exp [ n i \{ ψ ( x ) + {δ}_{k} \} ] \qquad ( 9 )$$

Wherein, “x” represents an X coordinate of the pixel 40. “A₀” represents the intensity of the incident X-rays, and “Aₙ” represents a value corresponding to the amplitude of the intensity modulation signal. “n” represents a positive integer, and “i” is an imaginary unit. “δₖ” is represented by the following expression (10):

$${δ}_{k} = 2 π \frac{k + {α}_{k}}{M} \qquad ( 10 )$$

In the above expression (9), with the neglect of higher-order terms of n≧2, the pixel value Iₖ(x) is represented as a sinusoidal wave by the following expression (11):

Iₖ(x)=A₀+A₁ cos [ψ(x)+δₖ] (11)

The pixel value Iₖ(x) satisfying the above expression (11) is a theoretical value. A measurement value that is actually obtained by the X-ray image detector 20 includes an error. To calculate the phase shift amount ψ(x) from the measurement value of the pixel value Iₖ(x), the above expression (11) is first transformed into the following expression (12):

Iₖ(x)=a₀+a₁ cos δₖ+a₂ sin δₖ (12)

Here, parameters a₀, a₁, and a₂ are represented by the following expressions (13) to (15):

a₀=A₀ (13)

a₁=A₁ cos ψ(x) (14)

a₂=A₁ sin ψ(x) (15)

Using the method of least square, the parameters a₀, a₁, and a₂ that minimize the difference between the theoretical value and the measurement value of the pixel value Iₖ(x) are determined. Thus, the phase shift amount ψ(x) is calculated as the following expression (16):

$$ψ ( x ) = - {tan}^{- 1} \frac{{a}_{2}}{{a}_{1}} \qquad ( 16 )$$

A calculation method of the phase shift amount using the method of least square is described on pages 196 to 198 of “The second edition of Applied Optics, Introduction to Optical Measurement, written by Toyohiko Yatagai, issued on Feb. 15, 2005 from Maruzen Publishing Co., Ltd.” By solving a determinant (17) led from the method of least square, the parameters a₀, a₁, and a₂ are determined.

a=A⁻¹(δₖ)B(δₖ) (17)

Here, matrixes a, A(δₖ) , and B(δₖ) are represented by the following expressions (18) to (20), respectively:

$$\begin{matrix} a = ( \begin{matrix}{a}_{0} \\ {a}_{1} \\ {a}_{2}\end{matrix} ) & ( 18 ) \\ A ( {δ}_{k} ) = ( \begin{matrix}1 & \frac{1}{M} {\sum }_{k = 0}^{M - 1} cos {δ}_{k} & \frac{1}{M} {\sum }_{k = 0}^{M - 1} sin {δ}_{k} \\ \frac{1}{M} {\sum }_{k = 0}^{M - 1} cos {δ}_{k} & \frac{1}{M} {\sum }_{k = 0}^{M - 1} {cos}^{2} {δ}_{k} & \frac{1}{M} {\sum }_{k = 0}^{M - 1} cos {δ}_{k} sin {δ}_{k} \\ \frac{1}{M} {\sum }_{k = 0}^{M - 1} sin {δ}_{k} & \frac{1}{M} {\sum }_{k = 0}^{M - 1} cos {δ}_{k} sin {δ}_{k} & \frac{1}{M} {\sum }_{k = 0}^{M - 1} {sin}^{2} {δ}_{k}\end{matrix} ) & ( 19 ) \\ B ( {δ}_{k} ) = ( \begin{matrix}\frac{1}{M} {\sum }_{k = 0}^{M - 1} {I}_{k} ( x ) \\ \frac{1}{M} {\sum }_{k = 0}^{M - 1} {I}_{k} ( x ) cos {δ}_{k} \\ \frac{1}{M} {\sum }_{k = 0}^{M - 1} {I}_{k} ( x ) sin {δ}_{k}\end{matrix} ) & ( 20 )\end{matrix}$$

Although the Y coordinate of each pixel 40 is not considered in the above description, carrying out similar calculations with respect to the Y coordinate of the pixel 40 allows obtainment of two-dimensional distribution ψ(x, y) of the phase shift amount in the X and Y directions. This distribution ψ(x, y) corresponds to the differential phase image.

In the above description, the expression (9) is transformed into the expression (11) with the neglect of the higher-order terms of n≧2. However, the above expressions (16) to (20) hold similarly if the terms of n≧2 are involved, because the higher-order terms of n≧2 are terms to be added by linear combination.

In the actual radiography, the differential phase image generator 50 calculates the first differential phase image ψ₁(x, y) based on the above expressions (16) to (20). In the preliminary radiography, the differential phase image generator 50 may calculate the second differential phase image ψ₂(x, y) based on the above expressions (16) to (20) on the condition of αₖ=0 in a like manner, but a simpler expression is usable in the case of αₖ=0.

A computing method in the case of αₖ=0 will be hereinafter described. In the case of αₖ=0, since δₖ takes values at equal intervals, all of non-diagonal components of the matrix on the right side of the expression (19) become zero, and the expression (19) is transformed into an expression (21).

$$A ( {δ}_{k} ) = ( \begin{matrix}1 & 0 & 0 \\ 0 & \frac{1}{2} & 0 \\ 0 & 0 & \frac{1}{2}\end{matrix} ) \qquad ( 21 )$$

Substituting the A(δₖ) into the expression (17), the parameters a₁ and a₂ are represented by the following expressions (22) and (23):

$$\begin{matrix}{a}_{1} = \frac{2}{M} {\sum }_{k = 0}^{M - 1} {I}_{k} ( x ) cos {δ}_{k} & ( 22 ) \\ {a}_{2} = \frac{2}{M} {\sum }_{k = 0}^{M - 1} {I}_{k} ( x ) sin {δ}_{k} & ( 23 )\end{matrix}$$

Thereby, the differential phase image generator 50 can calculate the second differential phase image ψ₂(x, y) based on the above expressions (16), (22), and (23) in the preliminary radiography. Note that, the second differential phase image ψ₂(x, y) is ascribable to a manufacturing error and distortion of the first and second gratings 21 and 22 that do not vary between the preliminary radiography and the actual radiography.

The subtraction processing section 52 subtracts the second differential phase image ψ₂(x, y) from the first differential phase image ψ₁(x, y). The correction of the scan position data can eliminate the effect of deviation in the scan position between the preliminary radiography and the actual radiography. Therefore, the corrected differential phase image obtained by the subtraction processing section 52 contains only the phase information of the sample H, and the image quality is improved.

Next, the operation of the X-ray imaging system 10 having the above structure will be described. When a preliminary radiography order is inputted from the operation unit 17a in the absence of the sample H, the scan mechanism 23 translationally moves the second grating 22 by the predetermined scan pitch (p₂/M). Whenever the second grating 22 reaches each scan position k, the X-ray source 11 emits the X-rays, and the X-ray image detector 20 detects the G2 image. Accordingly, the M number of image data is produced and recorded to the memory 13.

Then, the image processor 14 reads out the M number of image data from the memory 13. In the image processor 14, the differential phase image generator 50 produces the second differential phase image ψ₂(x, y), and inputs the image ψ₂(x, y) to the correction data storage 51 as the correction data. At the same time, the second non-detection area data corresponding to the sample non-detection area 20b is extracted from each of the M number of image data, and is recorded to the non-detection area data storage 55. The operation in the preliminary radiography is now completed.

After that, an actual radiography order is inputted form the operation unit 17a in the presence of the sample H, the scan mechanism 23 translationally moves the second grating 22 in a like manner as above. Whenever the second grating 22 reaches each scan position k, the X-ray source 11 emits the X-rays, and the X-ray image detector 20 detects the G2 image. Accordingly, the M number of image data is produced and recorded to the memory 13.

Then, the image processor 14 reads out the M number of image data from the memory 13. In the image processor 14, the non-detection area data extracting section 54 extracts the first non-detection area data corresponding to the sample non-detection area 20b from each of the M number of image data, and inputs the first non-detection area data to the positional deviation amount calculating section 56. At this time, the second non-detection area data recorded to the non-detection area data storage 55 is inputted to the positional deviation amount calculating section 56.

The positional deviation amount calculating section 56 statistically calculates the deviation amount αₖ of the scan position kin the actual radiography relative to the preliminary radiography, and inputs the deviation amount αₖ to the positional deviation amount correcting section 57. The positional deviation amount correcting section 57 makes a correction of the scan position data k in the actual radiography by adding the deviation amount αₖ. The corrected scan position data k+αₖ is inputted to the differential phase image generator 50.

The differential phase image generator 50 produces the first differential phase image ψ₁(x, y) using the corrected scan position data k+αₖ, and inputs the first differential phase image ψ₁(x, y) to the subtraction processing section 52. At this time, the second differential phase image ψ₂(x, y) recorded to the correction data storage 51 is inputted to the subtraction processing section 52, and the subtraction processing section 52 subtracts the second differential phase image ψ₂(x, y) from the first differential phase image ψ₁(x, y). Then, the corrected differential phase image is inputted to the phase contrast image generator 53. The phase contrast image generator 53 integrates the corrected differential phase image in the X direction, to produce the phase contrast image. This phase contrast image is recorded to the image storage 15, and then is displayed on the monitor 17b.

In the above embodiment, the deviation amount of the scan position in the actual radiography is calculated with respect to the intensity modulation signal in the preliminary radiography. When the first differential phase image is produced, the scan position data is corrected using the deviation amount. However, in contrast to this, a deviation amount of the scan position in the preliminary radiography may be calculated with respect to the intensity modulation signal in the actual radiography. In this situation, when the second differential phase image is produced, the scan position data is corrected based on the positional deviation amount.

In the above embodiment, the deviation amount of the scan position is statistically calculated using the data of pixels 40 contained in the sample non-detection area 20b. However, the positional deviation amount may be statistically calculated from data of all pixels 40, including the pixels 40 belonging to the sample detection area 20a. If the number of pixels is large, the effect of the sample H is little, and the calculation precision of the positional deviation amount is within an allowable range.

In the above embodiment, when the scan mechanism 23 translationally moves the second grating 22, an initial position of the scan position is set at k=0. The initial position may be set at any of k=0, 1, 2, . . . , M-1.

In the above embodiment, the phase contrast image is recorded to the image storage 15, and is displayed on the monitor 17b. However, the corrected differential phase image may be recorded to the image storage 15 and displayed on the monitor 17b instead of or in addition to the phase contrast image.

In the above embodiment, the differential phase image is defined as the two-dimensional distribution of the phase shift amount of the intensity modulation signal. However, the differential phase image may be defined as the two-dimensional distribution of any physical amount such as the refraction angle φ, as long as the physical amount is proportionate to a differential value of the phase shift amount distribution Φ(x).

In the above embodiment, the sample H is disposed between the X-ray source 11 and the first grating 21, but may be disposed between the first and second gratings 21 and 22.

Although a source grating (multi-slit) is not disposed behind the X-ray source 11 in this embodiment, the source grating may be provided behind the X-ray source 11 to disperse an X-ray focus.

In the above embodiment, the first and second gratings 21 and 22 linearly project the X-rays that have passed through their X-ray transparent sections, but the present invention is not limited to this structure. The present invention may be applied to the structure in which the X-rays are diffracted by the X-ray transparent sections, and produce the Talbot effect (refer to U.S. Pat. No. 7,180,979 corresponding to Japanese Patent No. 4445397). In this case, however, the distance between the first and second gratings has to be set at the Talbot distance. Also, in this case, a phase grating is available as the first grating instead of the absorption grating. The phase grating used as the first grating forms its self image, which is produced by the Talbot effect, in the position of the second grating.

The present invention is applicable to various types of radiation imaging systems for medical diagnosis, industrial use, nondestructive inspection, and the like. As the radiation, gamma rays or the like are available other than the X-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A radiation imaging system comprising:
first and second gratings oppositely disposed with coincidence of a grating direction;
a scan mechanism for changing a relative position between said first and second gratings to a direction orthogonal to said grating direction, so as to sequentially set said relative position at plural scan positions;
a radiographic image detector for capturing an image of radiation applied from a radiation source through said first and second gratings and producing image data, whenever said relative position is set at each of said scan positions;
a differential phase image generator for producing a differential phase image by obtaining a phase shift amount of an intensity modulation signal, said intensity modulation signal representing a change of each pixel value contained in said image data relative to said scan positions, said differential phase image generator producing a first differential phase image from said image data obtained in actual radiography performed in a presence of a sample, and producing a second differential phase image from said image data obtained in preliminary radiography performed in an absence of said sample;
a positional deviation amount calculating section for calculating a positional deviation amount in each of said scan positions between said preliminary radiography and said actual radiography by detection of a difference between said intensity modulation signal obtained in said preliminary radiography and said intensity modulation signal obtained in said actual radiography;
a positional deviation amount correcting section for correcting scan position data used by said differential phase image generator in producing one of said first and second differential phase images, based on said calculated positional deviation amount; and
a subtraction processing section for subtracting said second differential phase image from said first differential phase image.

2. The radiation imaging system according to claim 1,
wherein said radiographic image detector has plural pixels; and
wherein said positional deviation amount calculating section statistically calculates said positional deviation amount in each of said scan positions with use of said intensity modulation signal of each of said pixels.

3. The radiation imaging system according to claim 2,
wherein said radiographic image detector has a sample non-detection area upon which said radiation emitted from said radiation source is incident without passing through said sample; and
wherein said plural pixels used in calculation of said positional deviation amount belong to said sample non-detection area.

4. The radiation imaging system according to claim 2, wherein said positional deviation amount calculating section calculates said positional deviation amount of each of said scan positions on a pixel-by-pixel basis, and determines said positional deviation amount of each of said scan positions by detecting a peak value, an average value, or a median of frequency distribution of a pixel number relative to said positional deviation amount.

5. The radiation imaging system according to claim 1, wherein said positional deviation amount calculating section interpolates said pixel value between said scan positions next to each other in said intensity modulation signal obtained from one of said pixels in one of said actual radiography and said preliminary radiography, and calculates with reference to said interpolated intensity modulation signal said positional deviation amount at each of said scan positions in said intensity modulation signal obtained from said same pixel in the other one of said actual radiography and said preliminary radiography.

6. The radiation imaging system according to claim 5, wherein said positional deviation amount calculating section performs linear interpolation of said pixel value between said scan positions next to each other.

7. The radiation imaging system according to claim 5, wherein said positional deviation amount calculating section performs extrapolation of said pixel value in said intensity modulation signal obtained in said actual radiography or said preliminary radiography, to make said intensity modulation signal into a periodic wave of more than one period.

8. The radiation imaging system according to claim 1, wherein said differential phase image generator calculates said phase shift amount of said intensity modulation signal by using a computation expression based on least square.

9. The radiation imaging system according to claim 1, further comprising:
a phase contrast image generator for integrating said differential phase image produced by said differential phase image generator in a direction of changing said relative position, to produce a phase contrast image.

10. The radiation imaging system according to claim 1, wherein said first grating is an absorption grating, and projects said radiation incident from said radiation source onto said second grating in a geometrical-optics manner.

11. The radiation imaging system according to claim 1, wherein said first grating is a phase grating, and induces a Talbot effect in said radiation incident from said radiation source to form a self image in a position of said second grating.

12. A radiographic image processing method used in a radiation imaging system, said radiation imaging system including first and second gratings oppositely disposed with coincidence of a grating direction, a scan mechanism for changing a relative position between said first and second gratings to a direction orthogonal to said grating direction so as to sequentially set said relative position at plural scan positions, a radiographic image detector for capturing an image of radiation applied from a radiation source through said first and second gratings and producing image data, whenever said relative position is set at each of said scan positions, and a differential phase image generator for producing a differential phase image by obtaining a phase shift amount of an intensity modulation signal that represents a change of each pixel value contained in said image data relative to said scan positions, said radiographic image processing method comprising the steps of:
calculating a positional deviation amount in each of said scan positions between preliminary radiography and actual radiography by detecting a difference between said intensity modulation signal obtained in said preliminary radiography performed in an absence of a sample and said intensity modulation signal obtained in said actual radiography performed in a presence of said sample;
with use of said positional deviation amount, correcting scan position data used in producing one of first and second differential phase images by said differential phase image generator;
with use of said corrected scan position data, producing by said differential phase image generator said first differential phase image from said image data obtained in said actual radiography and said second differential phase image from said image data obtained in said preliminary radiography; and
subtracting said second differential phase image from said first differential phase image.
